(19) United States
(12) Patent Application Publication
(10) Pub. No.: US 2023/0319090 A1
(43) Pub. Date: Oct. 5, 2023

(54) Consolidating structured and unstructured security and threat intelligence with knowledge graphs

(71) Applicant: International Business Machines Corporation, Armonk, NY (US)

(72) Inventors: Youngja Park, Princeton, NJ (US); Jiyong Jang, White Plains, NY (US); Dhilung Hang Kirat, White Plains, NY (US); Josyula R. Rao, Briarcliff Manor, NY (US); Marc Philippe Stoecklin, White Plains, NY (US)

(21) Appl. No.: 18/205,681

(22) Filed: Jun. 5, 2023

Related U.S. Application Data
(62) Division of application No. 15/368,845, filed on Dec. 5, 2016, now abandoned.

(51) Int. Cl. H04L 9/40; G06F 16/901

(52) U.S. Cl. CPC H04L 63/1425; G06F 16/9024

(57) ABSTRACT

An automated method for processing security events. It begins by building an initial version of a knowledge graph based on security information received from structured data sources. Using entities identified in the initial version, additional security information is then received. The additional information is extracted from one or more unstructured data sources. The additional information includes text in which the entities (from the structured data sources) appear. The text is processed to extract relationships involving the entities (from the structured data sources) to generate entities and relationships extracted from the unstructured data sources. The initial version of the knowledge graph is then augmented with the entities and relationships extracted from the unstructured data sources to build a new version of the knowledge graph that consolidates the intelligence received from the structured data sources and the unstructured data sources. The new version is then used to process security event data.

### BACKGROUND

### Technical Field

This disclosure relates generally to cybersecurity offense analytics.

### Background of the Related Art

Today's networks are larger and more complex than ever before, and protecting them against malicious activity is a never-ending task. Organizations seeking to safeguard their intellectual property, protect their customer identities, avoid business disruptions, and the like, need to do more than just monitor logs and network flow data; indeed, many organizations create millions, or even billions, of events per day, and distilling that data down to a short list of priority offenses can be daunting.

Known security products include Security Incident and Event Management (SIEM) solutions, which are built upon rule-based mechanisms to evaluate observed security events. SIEM systems and methods collect, normalize and correlate available network data. One such security intelligence product of this type is IBM® QRadar® SIEM, which provides a set of platform technologies that inspect network flow data to find and classify valid hosts and servers (assets) on the network, tracking the applications, protocols, services and ports they use. The product collects, stores and analyzes this data, and it performs real-time event correlation for use in threat detection and compliance reporting and auditing. Using this platform, billions of events and flows can therefore be reduced and prioritized into a handful of actionable offenses, according to their business impact. While SIEM-based approaches provide significant advantages, the rules are either hard coded or parameterized with a threat feed with concrete indicators of compromise (IoCs). Thus, typically these solutions are able to detect only known threats, but for unknown threats, e.g., detected by means of a behavior based rule, are unable to identify root cause and assist the security analyst. Moreover, these systems can present implementation challenges, as they often rely on manual curation of any semi-structured and unstructured threat feeds, i.e., natural language text, by means of security professionals reading threat advisories and extracting IoCs.

Indeed, today's information on security and threat intelligence is siloed and fragmented in many different data sources. The information sources include, among others, blacklists, reputation databases, vulnerability databases, threat reports, news articles and blogs. Some of this security intelligence is maintained in structured representations, such as blacklists and vulnerability databases, whereas other intelligence sources, such as threat reports and blogs, are in unstructured (natural language) form. Each information source provides a different aspect of intelligence. For instance, structured sources such as blacklists provide a list of known malicious IP addresses or URLs. Vulnerability databases provides knowledge about new software vulnerability. On the other hand, unstructured sources such as threat reports and news articles may provide various types of detailed narrative information, e.g., information about a new vulnerability or a campaign including affected products, how to mitigate the risk, who might be behind the attack, etc. Cybersecurity experts and tools rely on structured data sources, which are carefully curated by domain experts, while human experts typically rely on unstructured data sources.

Currently, most security solutions rely on one or a small number of such information sources when investigating and recovering from a security incident. They do not or cannot capture connections among these sources, and they cannot consolidate intelligence among many IOCs. Thus, such approaches often miss out on the root cause of a security incident.

To address this problem, there have been some recent efforts to formalize security knowledge, and to build a security model or ontology, by both the research community and various commercial vendors. These efforts, however, are relatively small scale containing only a small set of concepts and relationships. Second, the approaches and data models that have been suggested provide only the data or ontology schema to support data formalization and sharing across different entities. They do not use real instances of such concepts or relationships in those models.

General knowledge graphs, such as Google Knowledge Graph, Yago, and Cyc, are also known in the prior art, and they are used to facilitate information retrieval and semantic web applications. These knowledge graphs, however, are manually-created, and they only provide general knowledge about well-known people, locations and events, as opposed to cybersecurity entities and events.

The prior art also includes information extraction tools that extract concepts and relationships based on syntactic analysis of sentences in text or pre-defined lexical patterns. In addition, there has been many research projects on entity extraction, and relationship extraction. These approaches, however, have several drawbacks with respect to their use for mining security and threat intelligence information. Thus, for example, many approaches are based on supervised machine-learning methods and require a large amount of annotated data to train the tools; this is very time- and labor-intensive. Further, often these tools rely primarily on syntactic structure and lexical patterns, and they are not able to filter out non-domain specific facts. Moreover, the accuracy of the state of the art technologies in this field is still relatively low, and thus resulting output is often quite noisy. Finally, existing NLP tools do not work well for security text data, because many security entities are linguistically ill-formed.

Presently, there remains a need to provide automated systems to build a large scale cybersecurity knowledge graph that can consolidate knowledge derived from both structured and unstructured information sources, and that can be used to facilitate search, filtering, and prioritization of hypotheses for security offenses. The subject matter of this disclosure addresses this need.

### BRIEF SUMMARY

According to this disclosure, a method, apparatus and computer program product for cybersecurity offense analytics extracts security and threat intelligence data from various structured and unstructured data sources, normalizes and links knowledge from those information sources into a consolidated form, typically as a knowledge graph (KG), and then provides this intelligence data for query and reasoning.

In one aspect, a method for processing security event data begins by building an initial version of a knowledge graph comprising nodes and edges, wherein the nodes represent entities, and the edges represent relationships between or among entities. The initial knowledge graph is based on security and threat intelligence information received from the one or more structured data sources. Using one or more entities identified in the initial version of the knowledge graph that has been built based on the security and threat intelligence information received from the one or more structured data sources, additional security and threat intelligence information is then received. The additional security and threat intelligence information is extracted from one or more unstructured data sources. The additional security and threat intelligence information includes text in which the one or more entities (from the structured data sources) appear. The text is then processed to extract relationships involving the one or more entities (from the structured data sources) to generate entities and relationships extracted from the unstructured data sources. Then, the initial version of the knowledge graph is then augmented with the entities and relationships extracted from the unstructured data sources to build a new version of the knowledge graph that consolidates security and threat information received from the structured data sources and the unstructured data sources. The new version of the knowledge graph is then used to process security event data.

According to a second aspect of this disclosure, an apparatus for processing security event data is described. The apparatus comprises a set of one or more hardware processors, and computer memory holding computer program instructions executed by the hardware processors to perform a set of operations such as described above.

According to a third aspect of this disclosure, a computer program product in a non-transitory computer readable medium for use in a data processing system for processing security event data is described. The computer program product holds computer program instructions executed in the data processing system and operative to perform operations such as described above.

According to a further aspect, preferably the system includes the capability to learn lexical and syntactic patterns and contexts where the entities and relationships (derived from the unstructured data sources) are found, and to use this pattern and contextual information to update rules and/or models that are used to further extract knowledge from the sources. Preferably, the extraction rules and/or models are weighted such that rules or models with higher confidence levels are then used to extract from the unstructured data sources additional entities and relationships that may not exist (or have been otherwise found) in the structured data sources.

The foregoing has outlined some of the more pertinent features of the subject matter. These features should be construed to be merely illustrative. Many other beneficial results can be attained by applying the disclosed subject matter in a different manner or by modifying the subject matter as will be described.

### BRIEF DESCRIPTION OF THE DRAWINGS

For a more complete understanding of the subject matter and the advantages thereof, reference is now made to the following descriptions taken in conjunction with the accompanying drawings, in which:

FIG. 1 depicts an exemplary block diagram of a distributed data processing environment in which exemplary aspects of the illustrative embodiments may be implemented;

FIG. 2 is an exemplary block diagram of a data processing system in which exemplary aspects of the illustrative embodiments may be implemented;

FIG. 3 illustrates a security intelligence platform in which the techniques of this disclosure may be practiced;

FIG. 4 depicts a high level process flow of a cognitive analysis technique in which the techniques of this disclosure may be used;

FIG. 5 depicts the cognitive analysis technique in additional detail;

FIG. 6 depicts how an offense context graph is augmented using a security knowledge graph; and

FIG. 7 depicts a process flow of a technique to consolidate structured and unstructured security and threat intelligence information according to this disclosure.

### DETAILED DESCRIPTION OF AN ILLUSTRATIVE EMBODIMENT

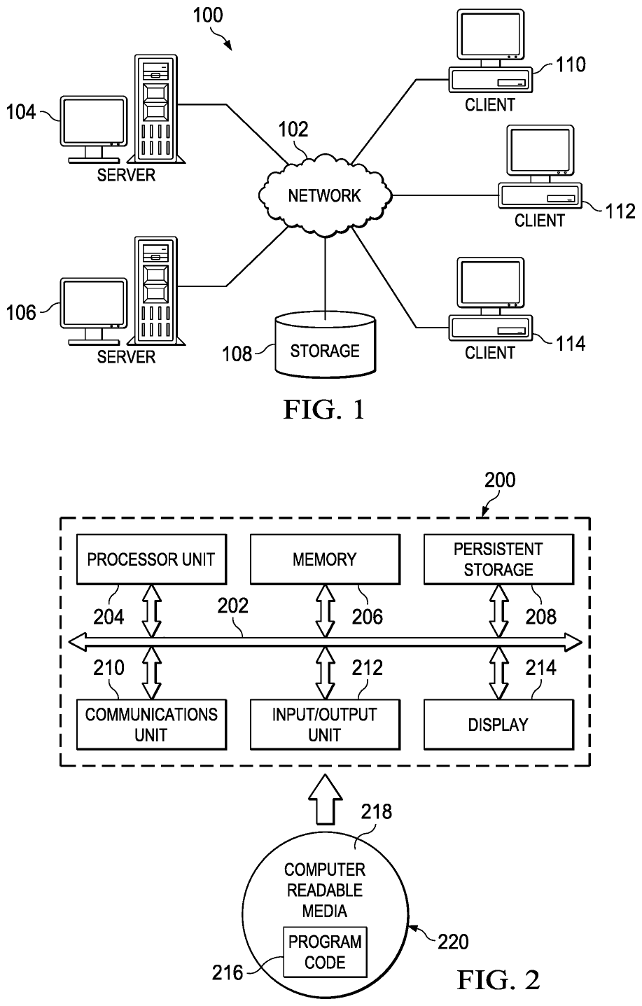

With reference now to the drawings and in particular with reference to FIGS. 1-2, exemplary diagrams of data processing environments are provided in which illustrative embodiments of the disclosure may be implemented. It should be appreciated that FIGS. 1-2 are only exemplary and are not intended to assert or imply any limitation with regard to the environments in which aspects or embodiments of the disclosed subject matter may be implemented. Many modifications to the depicted environments may be made without departing from the spirit and scope of the present invention.

With reference now to the drawings, FIG. 1 depicts a pictorial representation of an exemplary distributed data processing system in which aspects of the illustrative embodiments may be implemented. Distributed data processing system 100 may include a network of computers in which aspects of the illustrative embodiments may be implemented. The distributed data processing system 100 contains at least one network 102, which is the medium used to provide communication links between various devices and computers connected together within distributed data processing system 100. The network 102 may include connections, such as wire, wireless communication links, or fiber optic cables.

In the depicted example, server 104 and server 106 are connected to network 102 along with storage unit 108. In addition, clients 110, 112, and 114 are also connected to network 102. These clients 110, 112, and 114 may be, for example, personal computers, network computers, or the like. In the depicted example, server 104 provides data, such as boot files, operating system images, and applications to the clients 110, 112, and 114. Clients 110, 112, and 114 are clients to server 104 in the depicted example. Distributed data processing system 100 may include additional servers, clients, and other devices not shown.

In the depicted example, distributed data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, the distributed data processing system 100 may also be implemented to include a number of different types of networks, such as for example, an intranet, a local area network (LAN), a wide area network (WAN), or the like. As stated above, FIG. 1 is intended as an example, not as an architectural limitation for different embodiments of the disclosed subject matter, and therefore, the particular elements shown in FIG. 1 should not be considered limiting with regard to the environments in which the illustrative embodiments of the present invention may be implemented.

With reference now to FIG. 2, a block diagram of an exemplary data processing system is shown in which aspects of the illustrative embodiments may be implemented. Data processing system 200 is an example of a computer, such as client 110 in FIG. 1, in which computer usable code or instructions implementing the processes for illustrative embodiments of the disclosure may be located.

With reference now to FIG. 2, a block diagram of a data processing system is shown in which illustrative embodiments may be implemented. Data processing system 200 is an example of a computer, such as server 104 or client 110 in FIG. 1, in which computer-usable program code or instructions implementing the processes may be located for the illustrative embodiments. In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software that may be loaded into memory 206. Processor unit 204 may be a set of one or more processors or may be a multi-processor core, depending on the particular implementation. Further, processor unit 204 may be implemented using one or more heterogeneous processor systems in which a main processor is present with secondary processors on a single chip. As another illustrative example, processor unit 204 may be a symmetric multi-processor (SMP) system containing multiple processors of the same type.

Memory 206 and persistent storage 208 are examples of storage devices. A storage device is any piece of hardware that is capable of storing information either on a temporary basis and/or a permanent basis. Memory 206, in these examples, may be, for example, a random access memory or any other suitable volatile or non-volatile storage device. Persistent storage 208 may take various forms depending on the particular implementation. For example, persistent storage 208 may contain one or more components or devices. For example, persistent storage 208 may be a hard drive, a flash memory, a rewritable optical disk, a rewritable magnetic tape, or some combination of the above. The media used by persistent storage 208 also may be removable. For example, a removable hard drive may be used for persistent storage 208.

Communications unit 210, in these examples, provides for communications with other data processing systems or devices. In these examples, communications unit 210 is a network interface card. Communications unit 210 may provide communications through the use of either or both physical and wireless communications links.

Input/output unit 212 allows for input and output of data with other devices that may be connected to data processing system 200. For example, input/output unit 212 may provide a connection for user input through a keyboard and mouse. Further, input/output unit 212 may send output to a printer. Display 214 provides a mechanism to display information to a user.

Instructions for the operating system and applications or programs are located on persistent storage 208. These instructions may be loaded into memory 206 for execution by processor unit 204. The processes of the different embodiments may be performed by processor unit 204 using computer implemented instructions, which may be located in a memory, such as memory 206. These instructions are referred to as program code, computer-usable program code, or computer-readable program code that may be read and executed by a processor in processor unit 204. The program code in the different embodiments may be embodied on different physical or tangible computer-readable media, such as memory 206 or persistent storage 208.

Program code 216 is located in a functional form on computer-readable media 218 that is selectively removable and may be loaded onto or transferred to data processing system 200 for execution by processor unit 204. Program code 216 and computer-readable media 218 form computer program product 220 in these examples. In one example, computer-readable media 218 may be in a tangible form, such as, for example, an optical or magnetic disc that is inserted or placed into a drive or other device that is part of persistent storage 208 for transfer onto a storage device, such as a hard drive that is part of persistent storage 208. In a tangible form, computer-readable media 218 also may take the form of a persistent storage, such as a hard drive, a thumb drive, or a flash memory that is connected to data processing system 200. The tangible form of computer-readable media 218 is also referred to as computer-recordable storage media. In some instances, computer-recordable media 218 may not be removable.

Alternatively, program code 216 may be transferred to data processing system 200 from computer-readable media 218 through a communications link to communications unit 210 and/or through a connection to input/output unit 212. The communications link and/or the connection may be physical or wireless in the illustrative examples. The computer-readable media also may take the form of non-tangible media, such as communications links or wireless transmissions containing the program code. The different components illustrated for data processing system 200 are not meant to provide architectural limitations to the manner in which different embodiments may be implemented. The different illustrative embodiments may be implemented in a data processing system including components in addition to or in place of those illustrated for data processing system 200. Other components shown in FIG. 2 can be varied from the illustrative examples shown. As one example, a storage device in data processing system 200 is any hardware apparatus that may store data. Memory 206, persistent storage 208, and computer-readable media 218 are examples of storage devices in a tangible form.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache such as found in an interface and memory controller hub that may be present in communications fabric 202.

Computer program code for carrying out operations of the present invention may be written in any combination of one or more programming languages, including an object-oriented programming language such as Java™, Smalltalk, C++ or the like, and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Those of ordinary skill in the art will appreciate that the hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system, other than the SMP system mentioned previously, without departing from the spirit and scope of the disclosed subject matter.

As will be seen, the techniques described herein may operate in conjunction within the standard client-server paradigm such as illustrated in FIG. 1 in which client machines communicate with an Internet-accessible Web-based portal executing on a set of one or more machines. End users operate Internet-connectable devices (e.g., desktop computers, notebook computers, Internet-enabled mobile devices, or the like) that are capable of accessing and interacting with the portal. Typically, each client or server machine is a data processing system such as illustrated in FIG. 2 comprising hardware and software, and these entities communicate with one another over a network, such as the Internet, an intranet, an extranet, a private network, or any other communications medium or link. A data processing system typically includes one or more processors, an operating system, one or more applications, and one or more utilities. The applications on the data processing system provide native support for Web services including, without limitation, support for HTTP, SOAP, XML, WSDL, UDDI, and WSFL, among others. Information regarding SOAP, WSDL, UDDI and WSFL is available from the World Wide Web Consortium (W3C), which is responsible for developing and maintaining these standards; further information regarding HTTP and XML is available from Internet Engineering Task Force (IETF). Familiarity with these standards is presumed.

Security Intelligence Platform with Incident Forensics

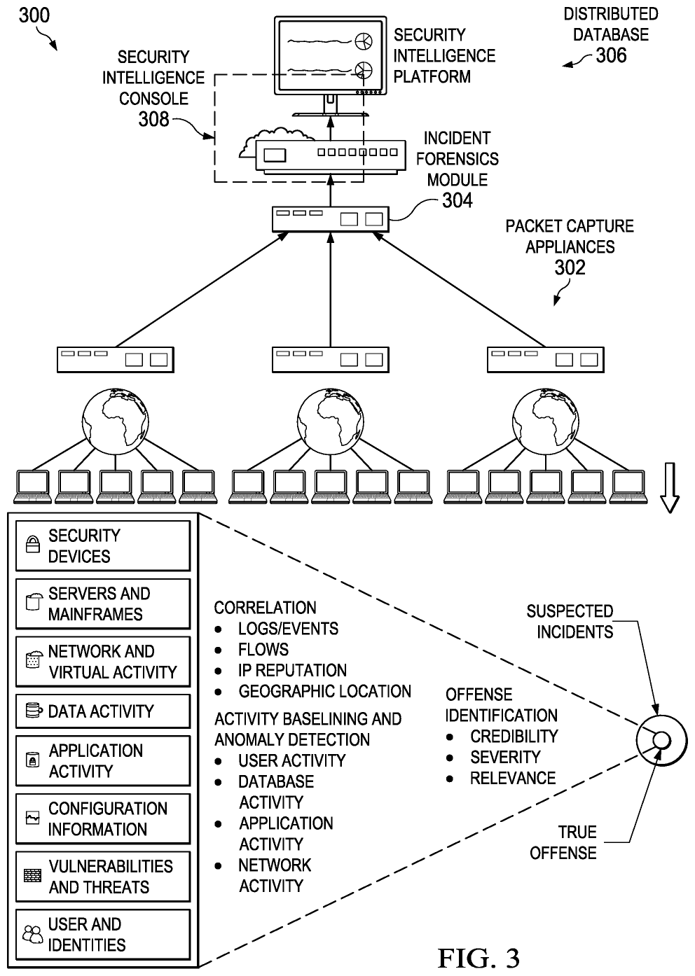

A representative security intelligence platform in which the techniques of this disclosure may be practiced is illustrated in FIG. 3. Generally, the platform provides search-driven data exploration, session reconstruction, and forensics intelligence to assist security incident investigations. In pertinent part, the platform 300 comprises a set of packet capture appliances 302, an incident forensics module appliance 304, a distributed database 306, and a security intelligence console 308. The packet capture and module appliances are configured as network appliances, or they may be configured as virtual appliances. The packet capture appliances 302 are operative to capture packets off the network (using known packet capture (pcap) application programming interfaces (APIs) or other known techniques), and to provide such data (e.g., real-time log event and network flow) to the distributed database 306, where the data is stored and available for analysis by the forensics module 304 and the security intelligence console 308. A packet capture appliance operates in a session-oriented manner, capturing all packets in a flow, and indexing metadata and payloads to enable fast search-driven data exploration. The database 306 provides a forensics repository, which distributed and heterogeneous data sets comprising the information collected by the packet capture appliances. The console 308 provides a web- or cloud-accessible user interface (UI) that exposes a “Forensics” dashboard tab to facilitate an incident investigation workflow by an investigator. Using the dashboard, an investigator selects a security incident. The incident forensics module 304 retrieves all the packets (including metadata, payloads, etc.) for a selected security incident and reconstructs the session for analysis. A representative commercial product that implements an incident investigation workflow of this type is IBM® Security QRadar® Incident Forensics V7.2.3 (or higher). Using this platform, an investigator searches across the distributed and heterogeneous data sets stored in the database, and receives a unified search results list. The search results may be merged in a grid, and they can be visualized in a “digital impression” tool so that the user can explore relationships between identities.

In particular, a typical incident forensics investigation to extract relevant data from network traffic and documents in the forensic repository is now described. According to this approach, the platform enables a simple, high-level approach of searching and bookmarking many records at first, and then enables the investigator to focus on the bookmarked records to identify a final set of records. In a typical workflow, an investigator determines which material is relevant. He or she then uses that material to prove a hypothesis or “case” to develop new leads that can be followed up by using other methods in an existing case. Typically, the investigator focuses his or her investigation through course-grained actions at first, and then proceeds to fine-tune those findings into a relevant final result set. The bottom portion of FIG. 3 illustrates this basic workflow. Visualization and analysis tools in the platform may then be used to manually and automatically assess the results for relevance. The relevant records can be printed, exported, or submitted processing.

As noted above, the platform console provides a user interface to facilitate this workflow. Thus, for example, the platform provides a search results page as a default page on an interface display tab. Investigators use the search results to search for and access documents. The investigator can use other tools to further the investigation. One of these tools is a digital impression tool. A digital impression is a compiled set of associations and relationships that identify an identity trail. Digital impressions reconstruct network relationships to help reveal the identity of an attacking entity, how it communicates, and what it communicates with. Known entities or persons that are found in the network traffic and documents are automatically tagged. The forensics incident module 304 is operative to correlate tagged identifiers that interacted with each other to produce a digital impression. The collection relationships in a digital impression report represent a continuously-collected electronic presence that is associated with an attacker, or a network-related entity, or any digital impression metadata term. Using the tool, investigators can click any tagged digital impression identifier that is associated with a document. The resulting digital impression report is then listed in tabular format and is organized by identifier type.

Generalizing, a digital impression reconstructs network relationships to help the investigator identify an attacking entity and other entities that it communicates with. A security intelligence platform includes a forensics incident module that is operative to correlate tagged identifiers that interacted with each other to produce a digital impression. The collection relationships in a digital impression report represent a continuously-collected electronic presence that is associated with an attacker, or a network-related entity, or any digital impression metadata term. Using the tool, investigators can click any tagged digital impression identifier that is associated with a document. The resulting digital impression report is then listed in tabular format and is organized by identifier type.

Typically, an appliance for use in the above-described system is implemented is implemented as a network-connected, non-display device. For example, appliances built purposely for performing traditional middleware service oriented architecture (SOA) functions are prevalent across certain computer environments. SOA middleware appliances may simplify, help secure or accelerate XML and Web services deployments while extending an existing SOA infrastructure across an enterprise. The utilization of middleware-purposed hardware and a lightweight middleware stack can address the performance burden experienced by conventional software solutions. In addition, the appliance form-factor provides a secure, consumable packaging for implementing middleware SOA functions. One particular advantage that these types of devices provide is to offload processing from back-end systems. A network appliance of this type typically is a rack-mounted device. The device includes physical security that enables the appliance to serve as a secure vault for sensitive information. Typically, the appliance is manufactured, pre-loaded with software, and then deployed within or in association with an enterprise or other network operating environment; alternatively, the box may be positioned locally and then provisioned with standard or customized middleware virtual images that can be securely deployed and managed, e.g., within a private or an on premise cloud computing environment. The appliance may include hardware and firmware cryptographic support, possibly to encrypt data on hard disk. No users, including administrative users, can access any data on physical disk. In particular, preferably the operating system (e.g., Linux) locks down the root account and does not provide a command shell, and the user does not have file system access. Typically, the appliance does not include a display device, a CD or other optical drive, or any USB, Firewire or other ports to enable devices to be connected thereto. It is designed to be a sealed and secure environment with limited accessibility and then only be authenticated and authorized individuals.

An appliance of this type can facilitate Security Information Event Management (SIEM). For example, and as noted above, IBM® Security QRadar® SIEM is an enterprise solution that includes packet data capture appliances that may be configured as appliances of this type. Such a device is operative, for example, to capture real-time Layer 4 network flow data from which Layer 7 application payloads may then be analyzed, e.g., using deep packet inspection and other technologies. It provides situational awareness and compliance support using a combination of flow-based network knowledge, security event correlation, and asset-based vulnerability assessment. In a basic QRadar SIEM installation, the system such as shown in FIG. 3 is configured to collect event and flow data, and generate reports. As noted, a user (e.g., an SOC analyst) can investigate offenses to determine the root cause of a network issue.

Generalizing, Security Information and Event Management (SIEM) tools provide a range of services for analyzing, managing, monitoring, and reporting on IT security events and vulnerabilities. Such services typically include collection of events regarding monitored accesses and unexpected occurrences across the data network, and analyzing them in a correlative context to determine their contribution to profiled higher-order security events. They may also include analysis of firewall configurations, network topology and connection visualization tools for viewing current and potential network traffic patterns, correlation of asset vulnerabilities with network configuration and traffic to identify active attack paths and high-risk assets, and support of policy compliance monitoring of network traffic, topology and vulnerability exposures. Some SIEM tools have the ability to build up a topology of managed network devices such as routers, firewalls, and switches based on a transformational analysis of device configurations processed through a common network information model. The result is a locational organization which can be used for simulations of security threats, operational analyses of firewall filters, and other applications. The primary device criteria, however, are entirely network- and network-configuration based. While there are a number of ways to launch a discovery capability for managed assets/systems, and while containment in the user interface is semi-automatically managed (that is, an approach through the user interface that allows for semi-automated, human-input-based placements with the topology, and its display and formatting, being data-driven based upon the discovery of both initial configurations and changes/deletions in the underlying network), nothing is provided in terms of placement analytics that produce fully-automated placement analyses and suggestions.

### Cognitive Offense Analysis Using Contextual Data and Knowledge Graphs

The following provides additional background concerning cognitive offense analytics.

In one embodiment, security event data is being processed in association with a cybersecurity knowledge graph (“KG”). The cybersecurity knowledge graph is derived one or more data sources and includes a set of nodes, and a set of edges. In one embodiment, processing proceeds as follows using a method. Preferably, the method is automated and begins upon receipt of information from a security system (e.g., a SIEM) representing an offense. Based on the offense type, context data about the offense is extracted, and an initial offense context graph is built. The initial offense context graph typically comprises a set of nodes, and a set of edges, with an edge representing a relationship between a pair of nodes in the set. At least one of the set of nodes in the offense context graph is a root node representing an offending entity that is determined as a cause of the offense. The initial offense context graph also includes one or more activity nodes connected to the root node either directly or through one or more other nodes of the set, wherein at least one activity node has associated therewith data representing an observable. The root node and its one or more activity nodes associated therewith (and the observables) represent a context for the offense. According to the method, the knowledge graph and potentially other data sources are then examined to further refine the initial offense context graph.

In particular, preferably the knowledge graph is explored by locating the observables (identified in the initial offense graph) in the knowledge graph. Based on the located observables and their connections being associated with one or more known malicious entities as represented in the knowledge graph, one or more subgraphs of the knowledge graph are then generated. A subgraph typically has a hypothesis (about the offense) associated therewith. Using a hypothesis, the security system (or other data source) is then queried to attempt to obtain one or more additional observables (i.e. evidence) supporting the hypothesis. Then, a refined offense context graph is created, preferably by merging the initial offense context graph, the one or more sub-graphs derived from the knowledge graph exploration, and the additional observables mined from the one or more hypotheses. The resulting refined offense context graph is then provided (e.g., to a SOC analyst) for further analysis.

An offense context graph that has been refined in this manner, namely, by incorporating one or more subgraphs derived from the knowledge graph as well as additional observables mined from examining the subgraph hypotheses, provides for a refined graph that reveals potential causal relationships more readily, or otherwise provides information that reveals which parts of the graph might best be prioritized for further analysis. The approach thus greatly simplifies the further analysis and corrective tasks that must then be undertaken to address the root cause of the offense.

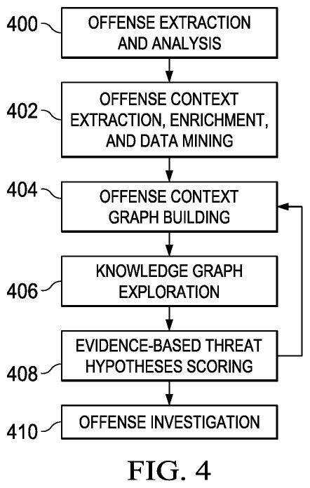

With reference now to FIG. 4, a high level process flow of the technique of this disclosure is provided The routine begins at step 400 with offense extraction and analysis. In this step, an offense is extracted from a SIEM system, such as IBM QRadar, for deep investigation. Typically, a detected offense may include many different entities, such as offense types, fired rules, user names, and involved indicators of compromise.

At step 402, the process continues with offense context extraction, enrichment and data mining. Here, offense context is extracted and enriched based on various information or factors such as, without limitation, time, an offense type, and a direction. This operation typically involves data mining around the offense to find potentially related events. The process then continues at step 404 to build an offense context graph, preferably with the offending entity as the center node and contextual information gradually connected to the center node and its children. Examples of contextual information can be represented by activity nodes in the graph. Typically, an activity comprises one or more observables, which are then connected to the respective activity, or directly to the center node.

The process then continues at step 406. In particular, at this step a knowledge graph is explored, preferably using a set of observables extracted from the offense context graph. This exploration step identifies related and relevant pieces of information or entities available from the knowledge graph. A primary goal in this operation is to find out how strongly the input observables are related to malicious entities in the knowledge graph. If the event related entities are strong malicious indicators, a hypothesis (represented by a subgraph in the knowledge graph) is generated. The process then continues at step 408. At this step, the resulting subgraph (generated in step 406) is mapped into the original offense context graph and scored. To reinforce the hypothesis (represented by the subgraph), additional evidence may be obtained (and built into the offense context graph) by querying local SIEM data for the presence of activities that are related to the hypothesis that is returned by the KG exploration in step 406. Additional findings as part of the hypothesis scoring may also be used to extend the offense context graph further and/or to trigger new knowledge graph explorations. Thus, step 408 represents an evidence-based scoring of the threat hypothesis.

The process then continues at step 410 with an offense investigation. At this point, the offense hypothesis includes the original offense IOCs (indicators of compromise), knowledge graph enrichment, evidence, and scores. The extended offense context graph is then provided to the SOC analyst (user) for offense investigation. The SOC user reviews the hypothesis that has been weighted in the manner described, and can then choose the right hypothesis that explains the given offense. There may be multiple hypotheses.

If additional or further exploration and more evidence are needed to make a decision, the SOC user can elect to nodes or edges in the offense context graph and repeat steps 406 and 408 as needed. This iteration is depicted in the drawing. This completes the high level process flow.

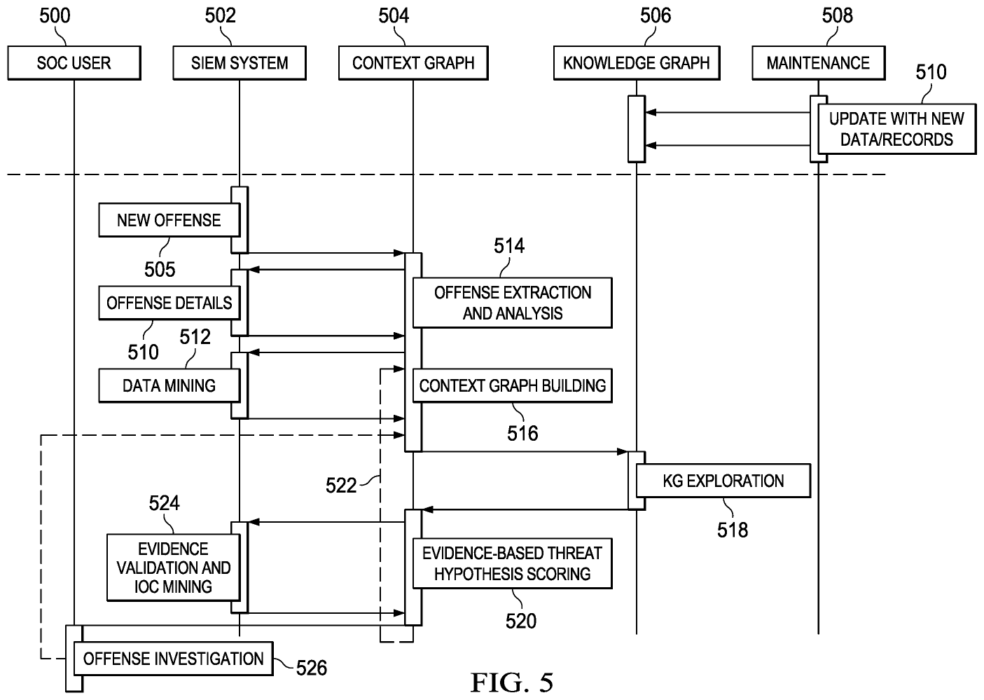

FIG. 5 depicts a modeling diagram showing the various entities involved in the technique and their interactions. As depicted, these entities include the SOC user 500, the SIEM system 502, the (offense) context graph 504, a knowledge graph 506, and a maintenance entity 508. Viewing the interactions from top to bottom, the knowledge graph 506 may be updated with new data/records 510 periodically; this operation is shown as an off-line operation (above the dotted line). The remainder of the figure depicts the process flow referenced above. Thus, the new offense 505 is identified by the SIEM system 502 and used together with the offense details 510 and data mining 512 to generate the context graph 504 via the offense extraction and analysis 514 and context graph building 516 operations. Once built, the knowledge graph 506 is explored 518 to identify one or more subgraphs. The evidence-based threat hypothesis scoring uses the subgraphs at operation 520, and the process may iterate (operation 522) as previously described. After evidence validation and IOC mining 524, the offense investigation 526 is then carried out, typically by the SOC user 500.

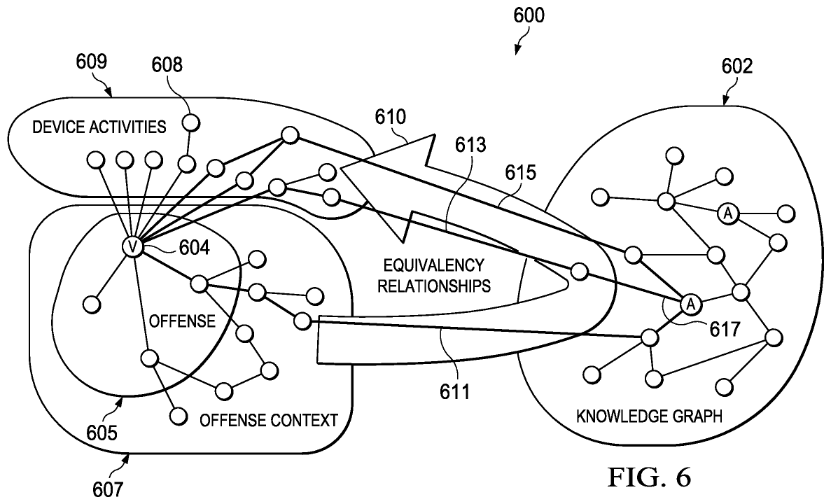

FIG. 6 depicts the offense context graph 600 augmented by the knowledge graph 602. In general, the offense context graph 600 depicts local kinetics, e.g., events and intelligence related to an offense, e.g., SIEM offense data, log events and flows, and such information preferably is augmented from the information derived from the knowledge graph 602. In this example embodiment, the knowledge graph is global in nature and scope, as it preferably depicts external cyber security and threat intelligence, cyber security concepts, and the like. Typically, and as will be described in more detail below according to this disclosure, the knowledge graph is informed by combining multiple structured and unstructured data sources. As shown, the offense context graph is centered around a root node 604 that has child nodes 606 within the “offense” 605. The “offense context” 607 includes still other nodes of relevance. There may also be a set of device activities 609 that include relevant device nodes 608. As depicted by the arrow 610, augmenting the context graph 600 using the knowledge graph 602 examines whether there is any path (such as one or more of paths 611, 613 or 615) from a node in the set of offense context nodes 607 to a node in the set of device activities 609 that passes through one or more nodes of the knowledge graph 602 (to which a threat activity is attached)? In the example shown, there is one or more such paths (611, 613 and 615), and the relevant subgraph 617 in the knowledge graph thus is captured and used to augment the offense context graph.

Thus, in the approach, details of an offense are extracted from a SIEM system, such as QRadar. The details typically include offense types, rules, categories, source and destination IP addresses, and user names. For example, an offense may be a malware category offense that indicates that malicious software is detected on a machine. Accordingly, activities of the machine around the offense need to be examined to determine infection vectors and potential data leakage. Of course, the nature of the activities that will need to be investigated will depend on the nature of the offense.

According to a further aspect of the approach, offense context related to an identified offense is then extracted and enriched depending on various factors, such as time, an offense type, and a direction. For example, if an offense type is a source IP, system and network activities of the same source IP (which may or may not be captured at other offenses) may then be collected. This collected context depicts potential casual relationships among events, and this information then provides a basis for investigation of provenance and consequences of an offense, e.g., Markov modeling to learn their dependencies. Of course, the nature of the offense context extraction and enrichment also depends on the nature of the offense.

From the contextual data extracted (as described above), an initial offense “context graph” 600 in FIG. 6 is built, preferably depending on offense types, such that a main offense source becomes a root 604 of an offense context graph, and offense details are then linked together around the root node. As noted above, the initial context graph preferably is then enriched and, in particular, by correlating local context, to further identify potential causal relationships among events. This helps analysts perform deep, more fine-grained investigation of provenance and consequences of the offense.

In this embodiment, provenance context preferably is extracted by identifying other offenses wherein the offense source is a target, e.g., an exploit target. Similarly, consequence context is extracted, preferably by finding other offenses wherein the offense source also is a source, e.g., a stepping stone. Similarly, consequence context is extracted by finding other offenses. Thus, this graph typically contains the offending entity (e.g., computer system, user, etc.) as the center (root) node of the graph, and contextual information is gradually connected to the node and its children. The result is the offense context 607 in FIG. 6. Examples of contextual information will depend on the nature of the offense; such information can be represented by activity nodes that include, without limitation, network activity, user activity, system activity, application activity, and so forth. Preferably, an activity comprises one or more observables, which are then connected to the respective activity nodes or directly to the center node. Further, the context graph can be extended with additional nodes representing information that does not directly relate to the original offense. For example, and by means of data mining (e.g., behavior-based anomaly detection, sequence mining, rule-based data extraction, and the like) of security-related events in temporal vicinity to the offense, additional activities of interest can be extracted and added to the context graph. This operation is represented in the graph by device activities 606.

Thus, in the approach as outlined so far, details of an offense are extracted from a SIEM system. The details include (but are not limited to) offense types, rules, categories, source and destination IPs, and user names. An initial offense context graph is built depending on offense types, such that the main offense source becomes the root of an offense context graph and offense details are linked together around the root node. The initial context graph is then enriched by correlating local context to further identify potential casual relationships among events, which helps analysts perform deep investigation of provenance and consequences of the offense. Provenance context is extracted by identifying other offenses where the offense source is a target, e.g., an exploit target. Similarly, consequence context is extracted by finding other offenses where the offense target is a source, e.g., a stepping stone. The enriched (and potentially dense) offense context graph is then pruned to highlight critical offense context for the SOC analyst's benefit. Typically, pruning is applied based on several metrics, such as weight, relevance, and time. For example, it may be desirable to assign weight to each event detail based on offense rules and categories to thereby indicate key features contributing to an offense.

Once the initial offense context graph is built, preferably that context graph is further enriched, validated and/or augmented based on information derived from a cybersecurity knowledge graph (KG) 602, which as noted above preferably is a source of domain knowledge. The knowledge graph, like the initial offense context graph, comprises nodes and edges. The cybersecurity knowledge graph can be constructed in several ways. In one embodiment, one or more domain experts build a KG manually. According to this disclosure, and as will be described below, preferably the KG 602 is built automatically or semi-automatically, e.g., from structured and unstructured data sources. As noted above, the context extraction and analysis processes provide a list of observables related to the given offense. According to this operation, the observables preferably are then enriched using the in-depth domain knowledge in the KG. This enrichment (or knowledge graph exploration) is now described.

In particular, this knowledge graph (KG) enrichment operation can be done in several different ways. In one approach, enrichment involves building sub-graphs related to the observables. To this end, the system locates the observables in the KG and discovers the connections among them. This discovery may yield one or more subgraphs (such as 617 in FIG. 6) showing the relationships of the given observables with other related security objects such as observables and threats. These subgraphs can provide a broader view on the given offense.

In another enrichment scenario, a SOC analyst can perform the query knowledge graph (KG) exploration step receives a set of observables, such as IP, URL, and files hashes, extracted from the SIEM offense. This exploration step seeks to identify all related and relevant pieces of information or entities available in the knowledge graph. The main goal is to find out how strongly the input observables are related to malicious entities in the knowledge graph. Some of the related entities can be strong malicious indicators, and thus a hypothesis about the offense can be generated. The related malicious entities might be strongly related among themselves, which also creates a hypothesis. Generalizing, an output of this step is a set of one or more hypotheses, which are consumed during the evidence-based threat hypothesis scoring operation where they are evaluated against local SIEM data. Preferably, and as noted above, the extraction of related entities is performed by traversing the knowledge graph, preferably starting from the input observables and extracting the subgraph. In general, unconstrained subgraph extraction may result in a very large and noise graph. Thus, preferably one or more traversal algorithms that focus on finding different types of related information by exploring the graph and pruning less relevant entities from the result may be deployed. One or more of these pruning algorithms may be run serially, in parallel, or otherwise. In addition, where possible coefficients of the graph entities are precomputed to enhance the efficiency of the graph traversal.

The following describes additional details of the evidence-based threat hypothesis scoring. Preferably, the knowledge graph exploration step returns a subgraph of observables, along with one or more annotations associated with the hypotheses. This subgraph preferably is then mapped into the original context graph. To reinforce the hypotheses, it may be desirable to build further relevant evidence, e.g., by querying local SIEM data for the presence of activities that are related to the hypotheses returned by the knowledge graph exploration. These activities may not have been flagged before by a simple rule-based offense monitor. This operation thus builds a merged graph that includes input from three sources, the original context graph, the knowledge graph exploration subgraph, and the additional observables queried for building the evidence for the hypotheses.

As also described, the final operation typically is offense investigation. Based on the prior operations described, the offense hypotheses now include the original offense IOCs, knowledge graph enrichment and supporting evidences, and their scores. This extended graph then is provided to an SOC analyst for an offense investigation. The SOC analyst reviews the weighted hypotheses and chooses the right hypothesis that explains the given offense. The selection itself may be automated, e.g., via machine learning. If further exploration and more evidence are needed to make a decision, the SOC can choose the nodes and/or edges of interest in the hypothesis graphs, and then repeat the above-described steps of knowledge graph exploration and evidence-based threat hypotheses scoring. During the hypothesis review process, the SOC may learn new facts and insights about the offense and, thus, add additional queries (e.g. observables or relationship) in a next iteration. The SOC analyst thus can use this iterative knowledge enrichment, evidence generation and hypothesis scoring to gain a deep understanding of the offense and actionable insights that may then be acted upon.

Thus, the basic notion of this approach is to use an autonomic mechanism to extract what is known about an offense (or attack), reason about the offense based on generalized knowledge (as represented by the knowledge graph), and thereby arrive at a most probable diagnosis about the offense and how to address it.

### Consolidating Structured and Unstructured Security and Threat Intelligence

The technique described above with respect to FIGS. 4-6 assumes the existence of cybersecurity knowledge graph (KG). The remainder of this disclosure is directed to an automated technique for building the cybersecurity KG and, in particular, by consolidating security and threat intelligence information from both structured and unstructured data sources. In particular, and according to this disclosure, the cybersecurity knowledge graph (KG) is formed by information that originates (or derived from) multiple structured and unstructured data sources. As described generally above, structured data sources provide security and threat intelligence information about “what/who are bad,” but typically such data sources lack in-depth knowledge about the threats, as well as actionable insights about how to address specific situations. Typically, structured data sources are carefully curated by domain experts. Examples include, without limitation, IBM X-Force Exchange, Virus Total, blacklists, Common Vulnerability Scoring System (CVSS) scores, and others. Unstructured data sources, in contrast, provide much more contextual information, such as why particular IP addresses or URLs are bad, what they do, how to protect users from known vulnerabilities, and the like. Examples of such unstructured data sources include, without limitation, threat reports from trusted sources, blogs, tweets, among others. Structured and unstructured knowledge thus exists separately, and even structured data sources are scattered and heterogeneous. While modern security tools (e.g., SIEM) can consult structured data sources directly, they do not have the capability to understand information in unstructured text, which typically is consumed manually only by human experts.

To address this problem, the technique of this disclosure builds what is referred to herein as a “consolidated” cybersecurity knowledge graph. Generally, the notion of “consolidated” herein refers to the inclusion of security and threat intelligence information in the graph from both structured and unstructured data sources. The nature and number of those data sources is not a limitation, although there is assumed to be at least one structured data source, and at least one unstructured data source. Also, the structured and unstructured data sources may comprise components in a given implementation, or those data sources may simply be the source of the information that the system will otherwise use to build the consolidated cybersecurity knowledge graph. In other words, the methods and systems herein may incorporate the structured and unstructured data sources in whole or in part, or those methods and systems may have the capability to obtain the security and threat intelligence information from those sources via conventional information retrieval, request-response protocols, NLP tools (such as Q&A systems), and the like. In the typical case, the structured and unstructured data sources are external to the implementation, but once again this is not a requirement.

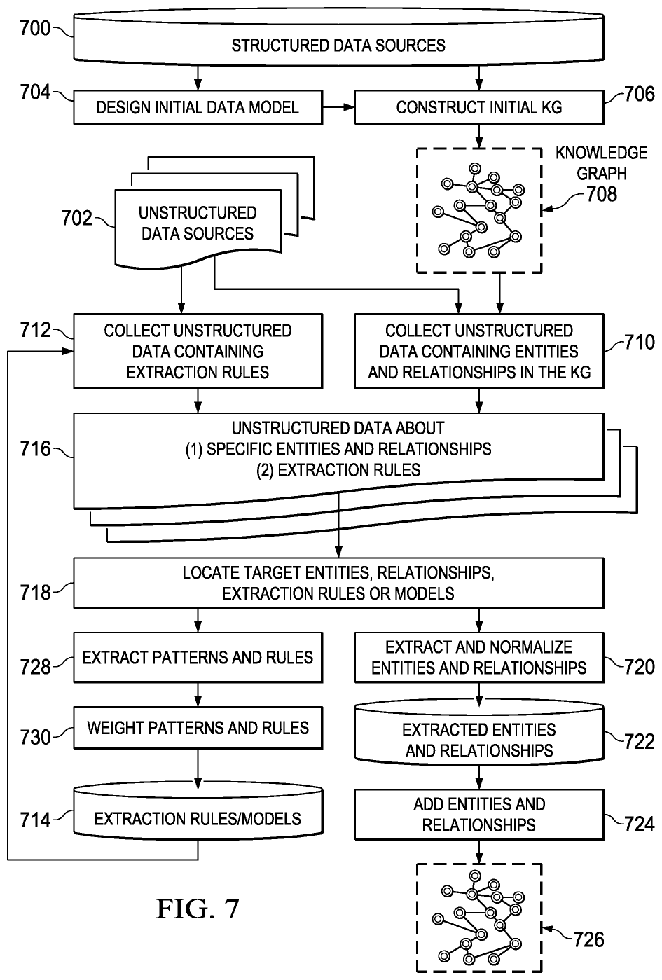

A basic operation of the method and system of this disclosure is depicted in FIG. 7. FIG. 7 is a process flow that may be implemented by a computer system or systems of the type described above. One or more of the depicted functions may be carried out across one or more computing entity components, whether co-located or distributed. Given functions that are shown as separate may be combined or otherwise integrated. The sequence of the operations may vary unless the context dictates others. In this example, and as described above, it is assumed that there are structured data sources 700, as well as unstructured data sources 702, that are available in (or to) the system.

A method of consolidation of security and threat intelligence information obtained from the structured and unstructured data source 700 and 702 begins at step 704. At this step, an initial data (or ontology) model is derived, based on information in the structured data sources 700. Optionally, the initial data model may be developed using requirements retrieved or obtained from a security application such as a SIEM or other network security device or system. The data model may be represented as a schema in a database, or in some equivalent format (e.g., a set of data tables, a linked list, an array, etc.) At step 706, an initial knowledge graph (KG) 708 is constructed from the initial data model and the security and threat intelligence information retrieved the structured data sources 700. Typically, step 706 is carried out by identifying domain entities (e.g., without limitation, IP addresses, URLs, hashes, etc.), and representing the underlying relationships between and among those entities. The building of an entity-relationship graph according to a data model and based on retrieved (or otherwise available) information is known in the art. The structured data retrieved from the structured data sources is used to construct the initial KG 708 because the data sources are reliable. As noted above, cybersecurity experts and tools rely on such data sources because they are carefully curated by domain experts.

The routine then continues at step 710. At step 710, unstructured text from an unstructured data source 702 is searched and collected for one or more entities (e.g., IP addresses, URLs, hashes, etc.) and relationships that are present in (or derived from) the initial KG 708. In other words, and according to a feature of this method and system, once the initial KG is developed from the structured data sources 700, the entities and relationships in that graph are used as a way to filter information retrieval (collection) from unstructured data sources 702. As noted above, unstructured data sources 702 may be part of the system, or such information may be obtained via conventional information retrieval techniques, tools and methods. Typically, the unstructured data sources 702 are third party (external) resources that are mined using search engines and the like. A Q&A system may be used in association with mining the unstructured data sources. This information may be collected or otherwise obtained in an automated or programmatic manner, or by manual processes. As also depicted in FIG. 7, in addition to identifying and collecting unstructured data (from the data sources 702) that contains entities and/or relationships found in the KG derived from the structured data sources, preferably the method also continues at step 712 to identify and collect unstructured data that contains or otherwise embodies (or satisfies) one or more extraction rules/models. As used herein, an “extraction” rule (or model) refers to some lexical, syntactical or structural pattern or other semantic that is present in the unstructured data sources 702, or that the system itself has identified through prior iterations as being pertinent. Thus, and as FIG. 7 also depicts, the system may include a set of extraction rules/models 714 that may be consulted in association with step 712.

Thus, according to this methodology, step 710 collects unstructured data containing entities and relationships in the knowledge graph 708. Step 712 collects unstructured data containing extraction rules even though no entities and relationships from the prior knowledge graph appear in the unstructured data. Steps 710 and 712 may be carried out concurrently or in a different sequence. They may be operations that are combined as well. The result of those collection operations is depicted at box 716, which represents the unstructured text in which the entities and relationships appear, and/or in which the relevant extraction rules or models appear.

The routine then continues at step 718 to process the unstructured text (collected and shown in box 716) to locate target entities or relationships, or extraction rules and/or models. Known processing techniques may be used for this purpose. Then, the routine continues at step 720, which preferably is a two-part operation. In a first part, the text in which the identified entities appear is processed to extract from the text the relationships involving those entities. The extraction of entities and relationships can be carried out using rule/pattern matching tools, or supervised machine learning (ML) models. Further, the rules and patterns learned (e.g., from the iterations of running the method herein) can be used to later train a supervised machine learning model. In the example scenario depicted, preferably both rule/pattern-based extraction and supervised learning model-based extraction approaches can be used, although this is not a requirement.

As used herein, “text” refers to a document, a set of documents, or other unstructured data. During the second part of this step, the extracted entities and their relationships also preferably are normalized. Normalization is useful because often a same entity or operation associated therewith is presented in unstructured text in many different ways (e.g., an IP address represented as IPv4, IPv6 or hexadecimal form, the same malware with different names such as “Locky,” “Locky malware” or “Locky ransomware,” equivalent operations such as “remove a file” and “delete a file,” etc.). In the normalization operation (the second part of step 720), the variations are processed such that all of the different expressions are combined into a canonical form. Normalization rules that are used in the process typically are security domain-specific entity normalization rules (e.g., mapping between IPv4 and IPv6), linguistic normalization rules (e.g., converting a spelled out IP address into IPv4), and so forth. The normalization process preferably uses information about synonyms, hypernyms, and paraphrasing, etc., to normalize these variations into the canonical form. By normalizing the data in this manner, the extracted entities and their relationships are appropriately captured from the unstructured data source(s)—as informed by the structured data source in the manner described. The result of step 720 is a set of extracted and normalized entities and relationships 722.

As depicted in FIG. 7, the extracted and normalized entities and relationships 722 are then added back into the KG 708. This addition (or “augmentation,” “supplementation” or “modification”) is carried out at step 724 and results in a composite knowledge graph 726. Further, the composite knowledge graph (or at the portions updated from the knowledge derived from the unstructured data sources) can include additional insights including, without limitation, identification of the unstructured data sources where the entities and relationships appeared, how many times an entity or a relationship was found, and the like. The data source and occurrence statistics can also be used to calculate a popularity level of the entities and relationships in the knowledge graph.

The composite knowledge graph 726 thus represents both structured and unstructured security and threat intelligence information (i.e. knowledge) that may be then be used to facilitate cognitive security analysis as previously described.

Unstructured data sources have the capability to add noise to the system. To address this, preferably the method also incorporates several additional operations. At step 728, the system also attempts to extract other patterns and rules that can then be re-used. Thus, at this step, one or more lexical, linguistic and document structural patterns and semantics of the extracted entities and their relationships are learned. The rules, patterns and semantics generated in this manner are then weighted at step 730. The weighting methodology may vary but, in an example embodiment, includes providing various weights based on occurrence counts and the confidence levels, e.g., of the underlying NLP tools used to capture and process the unstructured data sources. Preferably, and in connection with the weighting process, low confidence rules are discarded. This is because the knowledge extracted by rules with higher weights are more reliable, and because low weight rules might otherwise increase noisy results. The results are then used to update the extraction rules/models 714.

Thus, preferably the linguistic and structural patterns that produce high-confident knowledge facts are learned. In addition to extracting additional information about the entity (from the structured data), contextual and structural features where the entity and extracted relationships appear in text (e.g., a document obtained from an unstructured data source) are also extracted. These features are collected and ranked, and the features with a high confidence are learned. The features learned are then re-applied to unstructured text and extract more entities/relationships. More formally, the system preferably includes the capability to learn lexical and syntactic patterns and contexts where the entities and relationships (derived from the unstructured data sources) are found, and to use this pattern and contextual information to update rules and/or models that are used to further extract knowledge from the sources. Preferably, the extraction rules and/or models are weighted such that rules or models with higher confidence levels are then used to extract from the unstructured data sources additional entities and relationships that may not exist (or have been otherwise found) in the structured data sources.

Steps 710 through 730 are then repeated as necessary, periodically or continuously, to extract more entities, relationships, rules, etc. from the unstructured data sources.

The composite knowledge graph 726 may be tightly-consolidated, meaning that it includes all of the information derived from the structured data sources and the unstructured data sources, of the composite knowledge graph 726 may be more loosely-consolidated, meaning that it has two distinct parts, a “structured” portion, and an “unstructured” portion. In the latter case, the structured portion represents the information derived from the structured data sources, whereas the unstructured portion represents the information derived from the technique described in FIG. 7. There may be multiple iterations of that process, and thus multiple unstructured knowledge graph portions. In a typical scenario, a SIEM or other security system has associated therewith a knowledge graph interface that can be used to render the knowledge graph (or portions thereof) visually, to search and retrieve relevant information from the graph, and to perform other known input and output functions with respect thereto. One such use of the consolidated knowledge graph is to facilitate the cognitive analysis described above with respect to FIGS. 4-6.

Generalizing, multiple knowledge graphs derived from one or more unstructured data sources may be merged with a knowledge graph derived from one or more structured data sources to build a large scale cybersecurity knowledge graph. Different portions of the large scale cybersecurity knowledge graph may be hosted in different computing entities and/or data stores. During a security analysis, and in response to a user query, multiple subgraphs (e.g., a first subgraph representing first knowledge derived from structured data sources, and a second subgraph representing second knowledge derived from unstructured data sources) may be identified and then merged to provide a response to the information query.

The technique of this disclosure provides significant advantages. The technique builds an enriched knowledge graph that brings together what has previously been disconnected intelligence sources (namely, structured data, on the one hand, and unstructured data, on the other). Security tools (e.g., a SIEM) that is extended to include this functionality can thus provide both structured data source analysis (as they typically do), as well as unstructured data analysis. By using the consolidating knowledge graph to support cognitive analysis, potential causal relationships between security events and offenses can be exposed more readily, thereby helping the security analyst comprehend an offense more thoroughly. By providing an enhanced knowledge graph in the manner described, the approach enables the analyst to prioritize which parts of an offense graph to be investigated first, thereby leading to faster solution. The approach provides security analysts with more comprehensive context from a variety of kinetics data imported into a SIEM system. For deep and efficient investigation, the described approach leverages a comprehensive set of rules, and it offers enriched relevant context of an offense. The approach enables efficient mining of offense context (e.g., activities, device event details, offense rules and categories, etc.) and to provide a comprehensive knowledge graph for follow-on deep investigation and analysis.

A further advantage is that the system preferably includes the capability to learn lexical and syntactic patterns and contexts where the entities and relationships (derived from the unstructured data sources) are found, and to use this pattern and contextual information to update rules and/or models that are used to further extract knowledge from the sources. Preferably, the extraction rules and/or models are weighted such that rules or models with higher confidence levels are then used to extract from the unstructured data sources additional entities and relationships that may not exist (or have been otherwise found) in the structured data sources.

More generally, the approach herein provides for an enhanced data mining process on security data (e.g., a cybersecurity incident) to extract contextual data related to the incident, and to translate this information into a graph representation for investigation by a security analyst. The approach, being automated, is highly efficient, and it greatly eases the workflow requirements for the SOC analyst. By providing the enhanced KG, SOC analysts no longer have to consult unstructured data sources manually, which is very time-consuming and may not produce appropriate results. The KG construction technique of this disclosure provides a way to capture connections and consolidated intelligence among many IOCs, thereby facilitating improved security incident analytics and response.

The technique herein also provides for enhanced automated and intelligent investigation of a suspicious network offense so that corrective action may be taken. The nature of the corrective action is not an aspect of the described methodology, and any known or later-developed technologies and systems may be used for this purpose.

One of ordinary skill in the art will further appreciate that the technique herein automates the time-consuming and often difficult research and investigation process that has heretofore been the province of the security analyst. The approach retrieves knowledge about the IOCs using a consolidated-based knowledge graph preferably extracted from public and/or private structured and unstructured data sources, and then extends that knowledge even further, thereby greatly reducing the time necessary for the analyst to determine cause and effect.

As noted above, the approach herein is designed to be implemented in an automated manner within or in association with a security system, such as a SIEM.

The consolidated knowledge graph may be a component of the system, or such a graph may be used by the system.

Processing of unstructured data sources as described herein may be facilitated using a question and answer (Q&A) system, such as a natural language processing (NLP)-based artificial intelligence (AI) learning machine. A machine of this type may combine natural language processing, machine learning, and hypothesis generation and evaluation; it receives queries and provides direct, confidence-based responses to those queries. A Q&A solution such as IBM Watson may be cloud-based, with the Q&A function delivered “as-a-service” (SaaS) that receives NLP-based queries and returns appropriate answers.

A representative Q&A system, such as described in U.S. Pat. No. 8,275,803, provides answers to questions based on any corpus of data. The method described there facilitates generating a number of candidate passages from the corpus that answer an input query, and finds the correct resulting answer by collecting supporting evidence from the multiple passages. By analyzing all retrieved passages and that passage's metadata in parallel, there is generated an output plurality of data structures including candidate answers based upon the analyzing step. Then, by each of a plurality of parallel operating modules, supporting passage retrieval operations are performed upon the set of candidate answers; for each candidate answer, the data corpus is traversed to find those passages having candidate answer in addition to query terms. All candidate answers are automatically scored causing the supporting passages by a plurality of scoring modules, each producing a module score. The modules scores are processed to determine one or more query answers; and, a query response is generated for delivery to a user based on the one or more query answers.

In an alternative embodiment, the Q&A system may be implemented using IBM LanguageWare, a natural language processing technology that allows applications to process natural language text. LanguageWare comprises a set of Java libraries that provide various NLP functions such as language identification, text segmentation and tokenization, normalization, entity and relationship extraction, and semantic analysis.

The functionality described in this disclosure may be implemented in whole or in part as a standalone approach, e.g., a software-based function executed by a hardware processor, or it may be available as a managed service (including as a web service via a SOAP/XML interface). The particular hardware and software implementation details described herein are merely for illustrative purposes are not meant to limit the scope of the described subject matter.

More generally, computing devices within the context of the disclosed subject matter are each a data processing system (such as shown in FIG. 2) comprising hardware and software, and these entities communicate with one another over a network, such as the Internet, an intranet, an extranet, a private network, or any other communications medium or link. The applications on the data processing system provide native support for Web and other known services and protocols including, without limitation, support for HTTP, FTP, SMTP, SOAP, XML, WSDL, UDDI, and WSFL, among others. Information regarding SOAP, WSDL, UDDI and WSFL is available from the World Wide Web Consortium (W3C), which is responsible for developing and maintaining these standards; further information regarding HTTP, FTP, SMTP and XML is available from Internet Engineering Task Force (IETF). Familiarity with these known standards and protocols is presumed.

The scheme described herein may be implemented in or in conjunction with various server-side architectures including simple n-tier architectures, web portals, federated systems, and the like. The techniques herein may be practiced in a loosely-coupled server (including a “cloud”-based) environment.

Still more generally, the subject matter described herein can take the form of an entirely hardware embodiment, an entirely software embodiment or an embodiment containing both hardware and software elements. In a preferred embodiment, the function is implemented in software, which includes but is not limited to firmware, resident software, microcode, and the like. Furthermore, as noted above, the identity context-based access control functionality can take the form of a computer program product accessible from a computer-usable or computer-readable medium providing program code for use by or in connection with a computer or any instruction execution system. For the purposes of this description, a computer-usable or computer readable medium can be any apparatus that can contain or store the program for use by or in connection with the instruction execution system, apparatus, or device. The medium can be an electronic, magnetic, optical, electromagnetic, infrared, or a semiconductor system (or apparatus or device). Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD. The computer-readable medium is a tangible item.

The computer program product may be a product having program instructions (or program code) to implement one or more of the described functions. Those instructions or code may be stored in a computer readable storage medium in a data processing system after being downloaded over a network from a remote data processing system. Or, those instructions or code may be stored in a computer readable storage medium in a server data processing system and adapted to be downloaded over a network to a remote data processing system for use in a computer readable storage medium within the remote system.

In a representative embodiment, the knowledge graph generation and processing techniques are implemented in a special purpose computer, preferably in software executed by one or more processors. The software is maintained in one or more data stores or memories associated with the one or more processors, and the software may be implemented as one or more computer programs. Collectively, this special-purpose hardware and software comprises the functionality described above.

While the above describes a particular order of operations performed by certain embodiments of the invention, it should be understood that such order is exemplary, as alternative embodiments may perform the operations in a different order, combine certain operations, overlap certain operations, or the like. References in the specification to a given embodiment indicate that the embodiment described may include a particular feature, structure, or characteristic, but every embodiment may not necessarily include the particular feature, structure, or characteristic.

Finally, while given components of the system have been described separately, one of ordinary skill will appreciate that some of the functions may be combined or shared in given instructions, program sequences, code portions, and the like.

The techniques herein provide for improvements to another technology or technical field, e.g., security incident and event management (SIEM) systems, other security systems, as well as improvements to automation-based knowledge graph-based analytics.

As noted, an initial or refined consolidated graph as described herein may be rendered for visual display, e.g., to a SOC analyst, to facilitate a follow-on security analysis or other security analytics use.

Having described the invention, what we claim is as follows.

1-21. (canceled)

22. A cybersecurity analytics platform, comprising:
one or more hardware processors;
computer memory storing computer program instructions configured to provide a knowledge graph builder;
a data storage storing a consolidated knowledge graph representing cybersecurity threat intelligence knowledge derived from both one or more structured data sources, and one or more unstructured data sources, the one or more unstructured data sources having been identified by the knowledge graph builder by identifying entities and relationships found in an initial version of the knowledge graph representing knowledge derived from just the one or more structured data sources; and
an information retrieval system that receives an information query and, in response, identifies one or more portions of the consolidated knowledge graph from which a hypothesis about a security event can be generated.

23. The cybersecurity analytics platform as described in claim 22 wherein the knowledge graph builder is further configured to learn lexical and syntactic patterns and contexts where entities and relationships derived from the unstructured data sources are found, and to use this pattern and contextual information to update rules and/or models that are used to further extract knowledge from the unstructured data sources.

24. The cybersecurity analytics platform as described in claim 22 wherein the one or more portions are at least first and second subgraphs of the consolidated knowledge graph.

25. The cybersecurity analytics platform as described in claim 24 wherein the knowledge graph builder is further configured to merge the at least first and second subgraphs, the first subgraph representing knowledge derived from the structured data sources, and the second subgraph representing knowledge derived from the unstructured data sources.
